(19) United States
(12) Patent Application Publication
(10) Pub. No.: US 2025/0270143 A1
(43) Pub. Date: Aug. 28, 2025

(54) Method for producing carbonised or graphitised 3D objects

(71) Applicant: Nippon Kornmeyer Carbon Group GmbH, Windhagen (DE)

(72) Inventors: Torsten KORNMEYER, Königswinter (DE); David KLEIN, Hennef (Sieg) (DE)

(73) Assignee: Nippon Kornmeyer Carbon Group GmbH, Windhagen (DE)

(21) Appl. No.: 18/704,995

(22) PCT Filed: Oct. 13, 2022
(86) PCT No.: PCT/EP2022/078542

§ 371 Date: Apr. 26, 2024

(30) Foreign Application Priority Data
Nov. 1, 2021 (DE) 10 2021 128 414.7

(51) Int. Cl. C04B 35/573; C04B 35/65; C04B 35/83

(52) U.S. Cl. CPC C04B 35/573; C04B 35/65; C04B 35/83; C04B 2235/3418; C04B 2235/40; C04B 2235/5212; C04B 2235/5248; C04B 2235/602; C04B 2235/6562; C04B 2235/6567; C04B 2235/6581

(57) ABSTRACT

The invention relates to a method for producing carbonised or graphitised 3D objects which aims to realise such 3D objects particularly simply, and by means of which more complex 3D objects can also be produced without faults in the structure. This is achieved by mixing a carbonisable or graphitisable material with a free-flowing organic adhesive or a free-flowing thermoplastic organic substance to produce a kneadable, largely dimensionally stable compound and shaping the compound into a 3D blank, and by a subsequent drying and degassing process at an increased temperature over a predetermined period of time and subsequent carbonising or graphitising of the 3D blank in a furnace in a protective gas atmosphere to produce a 3D object, the temperature necessary for carbonising or graphitising being approached with a low heating gradient.

### CROSS-REFERENCE TO RELATED APPLICATION

This application is a national stage application, filed under 35 U.S.C. § 371, of International Patent Application PCT/EP2022/078542, filed on Oct. 13, 2022, which claims the benefit of German Patent Application DE 10 2021 128 414.7, filed on Nov. 1, 2021.

### TECHNICAL FIELD

The disclosure relates to a method for producing carbonized or graphitized 3D objects.

### BACKGROUND

Carbonized or graphitized 3D objects, which are also suitable for high-temperature applications, may be various components, such as linings for furnaces, construction components or else any desired hollow bodies, containers or crucibles.

Since it is not possible to produce the 3D objects by simple shaping of carbon black or graphite and subsequent sintering, a suitable carbon-containing and moldable compound generally needs to be produced. This commonly comprises mixing carbon black, cokes or graphites in the form of a granulate with a suitable binder, such as a thermoplastic binder. Useful binders also include pitch based on coal tar or on petroleum pitch, or else synthetic resins.

These mixtures are then molded to form a green molding by pressing and carbonized or graphitized in a furnace at about 3000° C., the binder decomposing into volatile constituents. What remain are carbon and binder coke as remnant of the binder in the form of a porous microstructure.

Alternatively, the green molding can also be arranged as a resistance element in a furnace between electrodes and heated by current flow.

The problem with carbonization or graphitization of such a molding is the more or less violent outgassing of volatile substances at the high temperatures required here, which can lead to microstructure defects, such as cracks or gas inclusions.

### SUMMARY

The invention has for its object to provide a method for producing carbonized or graphitized 3D objects which is particularly simple to realize and which allows production of even relatively complex 3D objects without microstructure defects.

This is achieved by preparation of a kneadable and largely dimensionally stable compound consisting of a carbonizable or graphitizable material and a free-flowing organic adhesive or a free-flowing thermoplastic organic material and shaping of the compound to form a 3D blank by hand using suitable templates, or by molding in a Teflon or silicone mold and removing the 3D blank from the mold, followed by a drying and outgassing process of the 3D blank at room temperature or at a maximum of 100° C. for conversion into a 3D molding, followed by a stabilization and homogenization process of the 3D molding at a temperature of 140° C. to a maximum of 450° C. in air and subsequent carbonization or graphitization of the 3D molded part in a furnace under or protective gas atmosphere for production of a 3D object, the temperature required for carbonization or graphitization being approached with a low heating ramp.

### DETAILED DESCRIPTION

A useful carbonizable or graphitizable material is preferably carbon black, graphite powder, natural graphite, pulp or corn starch, or a mixture of some or all of these materials.

In order to influence the strength or porosity of the 3D object to be produced, bamboo, cotton, hemp, sisal or graphite fibers can be added to the carbonizable or graphitizable material while maintaining kneadability. The protective gas used is preferably argon or helium.

Alternatively, the 3D blank, after the drying process, can be subjected to a stabilization and homogenization operation at a stabilization temperature of 170° C. in air or up to a maximum of 450° C. in air, preference being given to a temperature of 250° C., to form a 3D molding.

The stabilization and homogenization operation can in principle also be performed under a protective gas, such as argon.

The stabilization and homogenization of the 3D blank can also be effected while heating up the furnace.

In a further continuation of the invention, the 3D molding is carbonized to form a 3D object at a constant temperature of approx. 1000° C. until pure carbon of a different crystal structure is formed.

In another continuation of the invention, the 3D molding is graphitized at a constant temperature of above 2000° C.

Lastly, the 3D molding can be fully graphitized at a temperature of over 2500° C.

Preferably, the graphitization is effected with a heating ramp of about 1° C./min until the target temperature has been reached, followed by heat treatment for approx. 30 min, depending on the size of the 3D moldings.

In a particular embodiment of the invention, a metal powder or silicon powder can be added the kneadable compound, so that metal carbides or silicon carbides are formed in high-temperature treatment of the 3D molding at >1000° C. under protective gas.

The graphitized foamy 3D objects can also be converted into 3D objects made of SiC in a furnace at a temperature of >1200° C. with supply of gaseous SiO with argon as carrier gas at a pressure of approx. 30 mbar.

The invention is explained in more detail below on the basis of an exemplary embodiment.

In a first method step, a kneadable and largely dimensionally stable compound is prepared by mixing of a carbonizable or graphitizable material with a free-flowing organic adhesive or a free-flowing thermoplastic organic material, followed by shaping of the compound to form a 3D blank. Thereafter, moisture and gas inclusions in particular are removed from the 3D blank in a drying and outgassing process at elevated temperature, thereby converting said 3D blank into a 3D molding. This can avoid the formation of cracks on subsequent carbonization or graphitization of the 3D molding in a furnace under reduced pressure or protective gas, such as argon or helium, for production of a 3D object.

The carbonizable or graphitizable organic material used can be preferably carbon black, graphite powder, natural graphite, or starch, for example corn starch or potato starch or the like, or a mixture of some or all of these materials.

In order to influence the strength or porosity of the finished carbonized or graphitized 3D object, bamboo, cotton, hemp, sisal or other suitable plant fibers or graphite fibers can be added to the carbonizable or graphitizable organic material while maintaining kneadability, by adding further free-flowing adhesive or free-flowing organic material as required until the desired consistency has been reached.

The shaping of the 3D blank can be effected by hand, for example with the aid of templates, or by shaping in a mold, in which case the 3D blank should be removed from the mold before the drying process. In order to allow easier demolding of the 3D blanks, a mold made of Teflon, silicone or another material elastic to some extent can be used.

Alternatively, the 3D molding can be subjected to a drying process at room temperature or at a maximum of 100° C. in order to remove any water present. In a subsequent stabilization and homogenization operation at a stabilization temperature of 140° C. in air or up to a maximum of 450° C., under protective gas or reduced pressure, preference being given to a temperature of 250° C., outgassing takes place in order to avoid the formation of cracks on subsequent carbonization or graphitization.

It is understood that the 3D molding can remain in a suitable mold during the stabilization or homogenization operation.

The stabilization and homogenization of the 3D molding can also be effected while heating up the furnace.

The stabilization of the 3D molding is necessary to prevent destruction thereof on carbonization/graphitization, since the 3D molding might otherwise melt or greatly lose shape. During stabilization, rearrangement of the atoms/molecules occurs, so that they survive the high-temperature process.

In a further continuation, the 3D molding is carbonized in the furnace to form a 3D object at a constant temperature of approx. 1000° C. until pure carbon of a different crystal structure is formed.

In another continuation of the invention, the 3D molding is subsequently graphitized in the furnace to form a 3D object at a constant temperature of above 2000° C.

Lastly, the 3D molding can be fully graphitized in the furnace to form a 3D object at a temperature of over 2500° C.

It is understood that the carbonization or graphitization in the furnace must be effected under protective gas in order to avoid combustion of the organic constituents of the 3D blanks.

If the carbonization or graphitization is effected under reduced pressure, which is possible in principle, there is the risk that the pressure difference will cause acceleration of the volatile constituents between the inside of the 3D molding and the reduced pressure, thereby allowing formation of cracks.

For this reason, it is advantageous to provide a high pressure in the furnace, so that the volatile constituents diffuse out slowly, so that cracks and fractures can be safely avoided.

Preferably, the carbonization or graphitization is effected with a heating ramp of about 1° C./min until the target temperature has been reached, followed by heat treatment for approx. 30 min, with heat treatment for several hours also being possible.

In order to achieve uniform carbonization or graphitization, it is advisable to demold the 3D molding beforehand.

In a particular embodiment of the invention, a metal powder or silicon powder can be added the kneadable compound, so that metal carbides or silicon carbides are formed in high-temperature treatment of the 3D molding at >1000° C. under protective gas.

The graphitized foamy 3D objects can also be converted into 3D objects made of SiC in a furnace at a temperature of >1200° C. with supply of gaseous SiO with argon as carrier gas at a pressure of approx. 30 mbar.

1.-11. (canceled)

12. A method for producing carbonized or graphitized 3D objects, comprising:
mixing
a carbonizable or graphitizable material comprising one or more of carbon black, graphite powder, natural graphite, pulp, and corn starch with
a free-flowing organic adhesive or a free-flowing thermoplastic organic material to form a compound that is kneadable and dimensionally stable;
shaping the compound to form a 3D blank by hand with a template, or by molding in a mold made of Teflon or silicone and removing the 3D blank from the mold; followed by
drying and outgassing the 3D blank at room temperature or at a maximum of 100° C. for conversion into a 3D molding; followed by
stabilizing and homogenizing the 3D molding at a temperature between 140° C. and 450° C. in air; and subsequently
carbonizing or graphitizing the 3D molding by heat treatment in a furnace under a protective gas atmosphere and thereby producing a 3D object,
wherein a target temperature for the carbonizing or graphitizing is approached with a heating ramp of 1° C./min and then maintained during the heat treatment.

13. The method as claimed in claim 12, further comprising
adding bamboo, cotton, hemp, sisal, or graphite fibers to the carbonizable or graphitizable material while maintaining kneadability.

14. The method as claimed in claim 12,
wherein the stabilizing and homogenizing the 3D molding is performed while heating up the furnace.

15. The method as claimed in claim 12,
wherein the carbonizing or graphitizing the 3D molding is performed under reduced pressure or protective gas to form the 3D object at a constant temperature of 1000° C. until pure carbon of a different crystal structure is formed.

16. The method as claimed in claim 12,
wherein the carbonizing or graphitizing the 3D molding is performed in the furnace under reduced pressure or protective gas to form the 3D object at a constant temperature of above 2000° C.

17. The method as claimed in claim 12,
wherein the carbonizing or graphitizing the 3D molding is performed in the furnace under reduced pressure or protective gas to form the 3D object at a temperature of over 2500° C.

18. The method as claimed in claim 12,
wherein the protective gas atmosphere consists of argon or helium.

19. The method as claimed in claim 17,
wherein the carbonizing or graphitizing the 3D molding is graphitizing the 3D molding, and
wherein a duration of the heat treatment is longer than 30 minutes.

20. The method as claimed in claim 12, further comprising:
adding a metal powder or silicon powder to the compound,
wherein the target temperature is >1000° C.,
whereby the 3D object consists of metal carbides or silicon carbides.

21. The method as claimed in claim 12, further comprising
converting the 3D object after graphitizing into a 3D object made of SiC in the furnace or a further furnace at a temperature of >1200° C. with supply of gaseous SiO with argon as carrier gas at a pressure of 30 mbar.
